(19) United States
(12) Patent Application Publication
(10) Pub. No.: US 2007/0153713 A1
(43) Pub. Date: Jul. 5, 2007

(54) Transmission of media content stream

(76) Inventor: Akseli Anttila, Helsinki (FI)

Correspondence Address: Hollingsworth & Funk, LLC;Suite 125, 8009 34th Avenue South, Minneapolis, MN, 55425, US

(21) Appl. No.: 11/321,190

(22) Filed: Dec. 29, 2005

(51) Int. Cl. H04J 3/16; H04Q 11/00; H04J 3/18; H04J 3/22; H04Q 7/24; H04Q 7/00; H04L 12/16

(52) U.S. Cl. 370/270; 370/468; 370/477; 370/328; 370/338

(57) ABSTRACT

A solution for providing a media content stream to a mobile terminal of a wireless communication network is provided. The media stream content (e.g. Television programs) may be provided to the user terminals either through a conventional broadcasting system or through the wireless communication network. The user of the mobile terminal may choose which-system should be used in the reception. At least a portion of the media content being broadcasted through a broadcasting system may be transmitted to the mobile terminal through the wireless communication network at the same time.

### FIELD

The invention relates to wireless data transmission and, particularly, to wireless transmission of a media content stream from a content provider to a mobile terminal of a wireless communication network.

### BACKGROUND

Nowadays, a wide range of media services is provided to users of mobile communication devices. In addition to conventional radio broadcasting media services, visual media services are entering the field of media services. A visual service related to radio broadcasting has been proposed. In addition to broadcasting a conventional radio program through a radio broadcasting system, supplemental data related to the radio program may be transmitted to mobile terminals of a telecommunication network. The supplemental data is transmitted through the telecommunication network to mobile terminals which have subscribed for the supplemental data. The supplemental data may be displayed in a display unit of a mobile terminal and the supplemental data may include, for example, a play list, news reports, events, program list, etc.

Digital video broadcasting-hand held (DVB-H) is a standard for transmitting video media to mobile communication devices. According to the DVB-H standard-by ETSI (European Telecommunications Standards Institute), the media content is broadcasted to the mobile communication devices through a wireless broadcasting system. The DVB-H standard is basically an extension of the Digital video broadcasting-terrestrial (DVB-T) standard. DVB-H is a terrestrial digital TV standard that consumes less power at the receiver end than DVB-T, and it allows the receiver to move freely while receiving the transmission, thus making the DVB-H ideal for mobile phones and hand held computers to receive digital TV broadcasting over the DVB-H broadcasting system without using mobile phone networks at all.

### BRIEF DESCRIPTION OF THE INVENTION

An object of the invention is to provide an improved solution for providing a media content stream to mobile terminals of a wireless communication network.

According to an aspect of the invention, there is provided a method for providing a media content stream to mobile terminals of a wireless communication network. The method comprises broadcasting, through a broadcasting system, the media content stream to the mobile terminals, receiving, from a mobile terminal of the wireless communication network, a request for the transfer of at least a portion of the media content stream being broadcasted, the transfer of the at least a portion of the media content stream being requested to be carried out through a downlink channel of the wireless communication network, and transmitting, in response to the request, the at least a portion of the media content stream to the mobile terminal through the downlink channel of the wireless communication network while broadcasting the media content stream through the broadcasting system.

According to another aspect of the invention, there is provided a media content stream reception method carried out in a mobile terminal of a wireless communication network. The method comprises receiving a media content stream broadcasted through a broadcasting system, transmitting a downlink channel assignment request for the reception, through the wireless communication network, of at least a portion of the media content stream being broadcasted through the broadcasting system, receiving the at least a portion of the media content stream through the wireless communication network, and presenting the received media content stream to a user of the mobile terminal.

According to another aspect of the invention, there is provided an arrangement for providing media content to mobile terminals of a wireless communication network. The arrangement comprises a media content production unit configured to produce a media content stream to be transmitted to the mobile terminals, a broadcasting system configured to broadcast the media content stream to the mobile terminals, and a wireless communication network configured to transmit, in response to a request from a mobile terminal, at least a portion of the media content stream being broadcasted by the broadcasting system.

According to another aspect of the invention, there is provided a mobile terminal of a wireless communication network. The mobile terminal comprises a media content receiver configured to receive a media content stream broadcasted through a broadcasting system, a communication interface configured to transmit and receive data through the wireless communication network, an audiovisual interface for presenting the received media content stream to a user of the mobile terminal, and a processing unit configured to transmit a downlink channel assignment request to the wireless communication network for the reception of at least a portion of the media content stream being broadcasted through a broadcasting system, to receive, through the communication interface, the at least a portion of the media content stream, and to present the received media content stream to a user of the mobile terminal through the audiovisual interface.

According to yet another aspect of the invention, there is provided an arrangement for transferring media content. The arrangement comprises a media content production unit configured to produce a media content stream to be transmitted to mobile terminals of a wireless communication network, a broadcasting system configured to broadcast the media content stream to the mobile terminals, a wireless communication network configured to transmit, in response to a request from a mobile terminal, at least a portion of the media content stream being broadcasted by the broadcasting system, and a mobile terminal of the wireless communication network. The mobile terminal comprises a media content receiver configured to receive a media content stream broadcasted through a broadcasting system, a communication interface configured to transmit and receive data through the wireless communication network, an audiovisual interface for presenting the received media content stream to a user of the mobile terminal, and a processing unit configured to transmit a downlink channel assignment request to the wireless communication network for the reception of at least a portion of the media content stream being broadcasted through a broadcasting system, to receive, through the communication interface, the at least a portion of the media content stream, and to present the received media content stream to a user of the mobile terminal through the audiovisual interface.

According to another aspect of the invention, there is provided a computer program distribution medium readable by a computer and encoding a computer program of instructions for executing a computer process for media content stream reception in a mobile terminal of a wireless communication network. The process comprises transmitting a downlink channel assignment request for the reception, through the wireless communication network, of at least a portion of the media content stream being broadcasted through a broadcasting system, receiving the at least a portion of the media content stream through the wireless communication network, and presenting the received media content stream to a user of the mobile terminal.

According to another aspect of the invention, there is provided a computer program distribution medium readable by a computer and encoding a computer program of instructions for providing a media content stream to mobile terminals of a wireless communication network. The process comprises broadcasting through a broadcasting system the media content stream to the mobile terminals, receiving from a mobile terminal of the wireless communication network a request for the transfer of at least a portion of the media content stream being broadcasted, the transfer of the at least a portion of the media content stream being requested to be carried out through a downlink channel of the wireless communication network, converting the media content stream to a format suitable for transmission through the wireless communication, and transmitting, in response to the request, the at least a portion of the media content stream to the mobile terminal through the downlink channel of the wireless communication network while broadcasting the media content stream through the broadcasting system.

The invention provides several advantages. The invention provides a solution for those users who want to be up to date on the broadcasted media content such as television programs, but who do not have the time or ability to fully concentrate on the media content. Additionally, if the mobile terminal of the user is temporarily incapable of receiving the broadcasted media content, the invention-provides a more reliable solution for delivering a version of the broadcasted media content to the user. Thus, the user will not be prevented from following the content of high interest to the user, such as breaking news or a sports event, due to a failure in the reception of the broadcasted media content.

### LIST OF DRAWINGS

In the following, the invention will be described in greater detail with reference to the embodiments and the accompanying drawings, in which

FIG. 1 illustrates the structure of a mobile terminal according to an embodiment of the invention;

FIG. 2 illustrates the structure of a system for providing media content according to an embodiment of the invention;

FIG. 3 illustrates an example of media stream content transmitted through a wireless communication network according to an embodiment of the invention;

FIG. 4 illustrates a signaling diagram for providing and receiving a media content stream according to an embodiment of the invention;

FIG. 5 illustrates a mobile terminal switching display modes for displaying received media stream content according to an embodiment of the invention; and

FIG. 6A illustrates a mobile terminal switching display modes for displaying a received media stream content according to an embodiment of the invention

FIG. 6B illustrates a mobile terminal switching display modes for displaying a received media stream content according to an embodiment of the invention

FIG. 7 is a flow diagram describing a process for providing media content to mobile terminals of a wireless communication network according to an embodiment of the invention, and

FIG. 8 is a flow diagram describing a process for receiving and presenting media content in a mobile terminal of a wireless communication network according to an embodiment of the invention.

### DESCRIPTION OF EMBODIMENTS

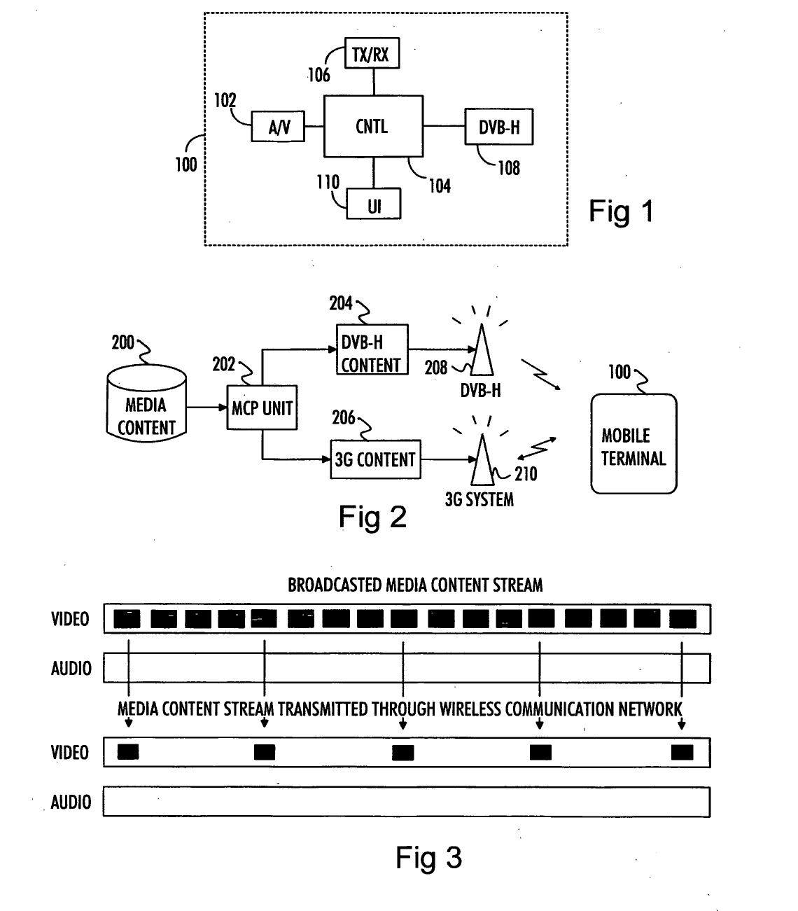

With reference to FIG. 1, let us examine an example of a mobile terminal 100 of a wireless communication network, to which embodiments of the invention can be applied. The mobile terminal 100 may be for example a personal communication device, such as a mobile communication device, a mobile phone, a laptop, or a PDA (Personal Digital Assistant).

The mobile terminal 100 comprises a communication interface 106 configured to provide a communication connection with the wireless communication network. The wireless communication network may be, for example, a wireless local area network (WLAN) or a mobile phone network, such as GSM (global system for mobile communication), GPRS (general packet radio service), EDGE (enhanced data rates for GSM evolution), UMTS (universal mobile telecommunication system), CDMA 2000, etc. The communication interface 106 is configured to communicate with the wireless communication network according to data transfer schemes applied in the wireless communication network. The data transfer may be divided into uplink and downlink data transmission.

The mobile terminal 100 further comprises a media content receiver 108 configured to receive a media content stream broadcasted through a broadcasting system. The media content receiver 108 may be configured to receive a media content stream transmitted according to digital video broadcasting-handheld (DVB-H) standard.

The mobile terminal 100 further comprises an audiovisual interface 102 for presenting information to a user of the mobile terminal 100. The audiovisual interface 102 may comprise a display unit and a sound production system comprising an amplifier and a speaker, and the audiovisual interface 102 may be configured to present the received media content stream to the user. The video component of the media content stream may be displayed in the display unit while an audio component of the media content stream may be played through the speaker. The audiovisual interface 102 may comprise more than one display units and an output for headphones, for example.

The mobile terminal 100 further comprises a user input device 110 configured to receive inputs from the user of the mobile terminal. The user input device 110 may comprise a keyboard or a keypad. The audiovisual interface 102 and the user input device 110 may also be integrated into a touch sensitive display unit. The mobile terminal 100 may also have a separate audiovisual interface and/or input components which communicate with the main terminal component using Bluetooth or infrared communication means, for example.

The mobile terminal 100 further comprises a processing unit 104 configured to control the operations of the mobile terminal 100. The processing unit 104 may be configured to process information being transmitted or received through the communication interface 106. The processing unit 104 may also be configured to control the audiovisual interface 102 and process inputs received from the user input device 110. In particular, the processing unit 104 may be configured to process media stream content received either through the media content receiver 108 or through the communication interface 106. The processing unit 104 may also control the communication with the wireless communication network. The processing unit 104 may be implemented with a digital signal processor provided with suitable software embedded in a computer readable medium, or with separate logic circuits, for example with ASIC (Application Specific Integrated Circuit).

Next, the provision of media stream content according to an embodiment of the invention will be described with reference to FIG. 2. A media content production unit 202 generates a media content stream to be transmitted to receivers. The media content production unit 202 may, for example, generate digital television content including programs on one or several television channels. A media content storage 200 may store the media content to be transmitted, and the media content production unit 202 may acquire the media content to be transmitted from the media content storage unit 200.

The media content production unit 202 may then output the generated media content to a DVB-H content creation unit 204 and to a content creation unit 206 for the creation of media content to be transmitted through a wireless communication network. In this example, the content creation unit 206 (3G content creation unit) creates media content to be transmitted through 3^{rd}-generation mobile phone network, e.g. UMTS or CDMA 2000, but it should be appreciated that the content creation unit 206 may also create the media content for transmission through another mobile phone network or through the Internet and a WLAN.

The DVB-H content creation unit 204 processes the received media content stream into a format suitable for broadcasting over a DVB-H broadcasting system 208, i.e. according to the DVB-H standard. The DVB-H content creation unit 204 then outputs the processed media content to be broadcasted to the broadcasting system 208 which broadcasts the media content stream according to the DVB-H standard. The DVB-H broadcasting system utilizes a so-called time slicing principle where data is provided for terminals in bursts. Data is transmitted in a compressed form using high throughput in short bursts which are separated by much larger gaps during which the terminal may stream data received during the previous burst. Parameters of the actual network implementation may vary but current implementations use approximately a 10% stream rate where audio and video data for about the next 2 seconds is transmitted in approximately 300 ms bursts. The broadcasted media content stream is received by the mobile terminal 100.

The 3G content creation unit 206 converts the received media content stream into a format suitable for transmission through the 3G mobile communication network 210. The content creation unit may reduce the data rate of the media content stream to a data rate more suitable for the mobile communication network.

FIG. 3 illustrates an example on how the 3G content creation unit 206 may reduce the data rate of the received media content stream. FIG. 3 illustrates a media content stream broadcasted through the broadcasting system 208. The media content stream has been divided into a video component and an audio component. The video component may be compressed according to a determined procedure (for example MPEG 2). The audio component may also be compressed. Both the video and audio component are transmitted through the broadcasting system 208 such that a user experiences them as a continuous stream. FIG. 3 also illustrates a media content stream transmitted through the wireless communication network (3G mobile communication network 210 in our example). This media content stream may be processed from the media content stream output from the media content production unit 202 by the 3G content creation unit 206. The 3G content creation unit 206 may extract the received media content stream into a video component and an audio component as illustrated in FIG. 3. The 3G content creation unit 206 may reduce the data rate of the audio component such that the data rate of the audio component becomes lower than the data rate of the broadcasted audio component. This reduction in the data rate may be achieved by encoding the audio component with a coding scheme that produces the desired data rate. The resulting audio component may be of a lesser quality than the audio component broadcasted through the broadcasting system 208. With respect to the video component of the media content stream, the 3G content creation unit 206 may clip the video component into still images in order to reduce the data rate of the video component. The 3G content creation unit 206 may obtain an image from the video component stream at determined time instants. The time interval between two images may be, for example, one second. The content creation unit 206 may also analyse the video stream in real time and choose the images which show major changes in the video content, so-called key frames, for example when a scene changes. Alternatively, the content creation unit 206 may analyse the audio stream in real time and obtain a still image upon detection of a major change in the audio component. Such a major change may be, for example, a rapid change in the volume of the audio component. The 3G content creation unit 206 may also downscale the obtained images into images with a lower resolution. Thus, the data rate required for the transmission of the 3G media content stream is lower than that of the media content stream broadcasted through the broadcasting system 208. The user experiences the audio component of the 3G media content stream as a continuous stream and receives images at determined time intervals as the video component of the 3G media content stream.

The data rate of the media content stream transmitted through the wireless communication network may also vary. For example, the user may define the data rate of the media content stream according to the desired quality of the received media content stream. If the user wishes a high quality media content, i.e. a high data rate stream, the video component of the media content stream may comprise images transmitted more frequently. The video component may also comprise streaming video. The audio component may also be of a higher quality.

The 3G content creation unit 206 then outputs the 3G media content stream to a 3G communication network 210 for transmission to mobile terminals 100 which have requested the transmission of the media content stream through the 3G communication network.

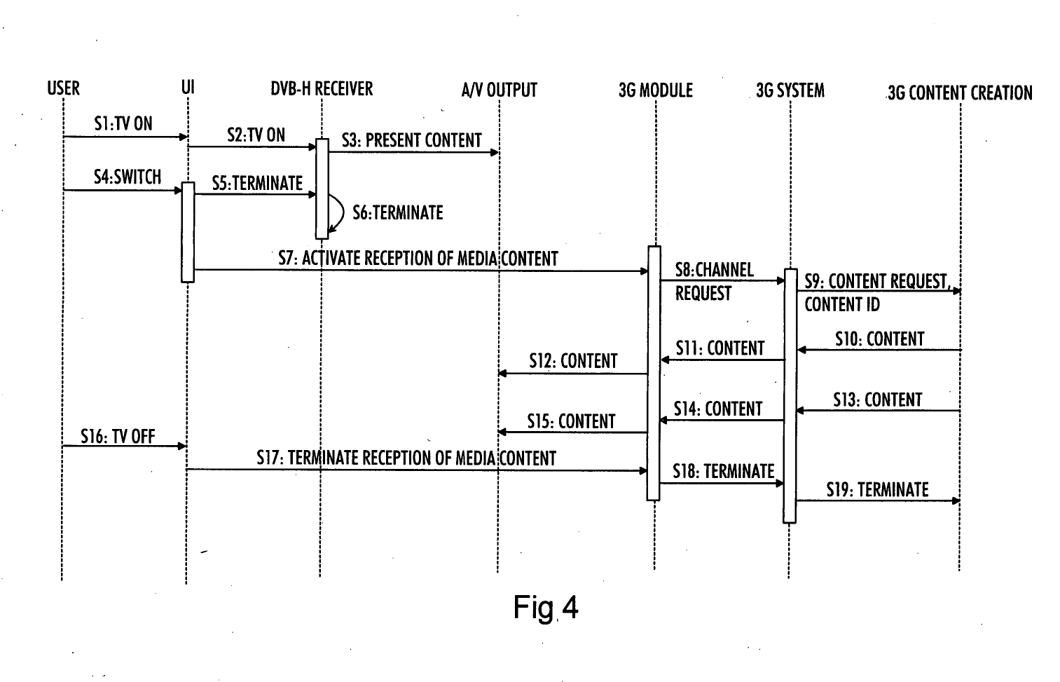

FIG. 4 illustrates a signaling diagram for providing and receiving a media content stream according to an embodiment of the invention. In FIG. 4, it is assumed that a DVB-H media content stream is being broadcasted all the time through the DVB-H broadcasting system 208 and a receiver may choose to receive or not to receive the broadcasted media content stream. The signaling diagram in FIG. 4 illustrates the actions of a user as well as the operations performed by the mobile terminal, and the communication between the mobile terminal 100 and the 3G mobile communication network 210. The processing unit 104 of the mobile terminal 100 may control the transfer of commands and information between the different units of the mobile terminal 100.

In S1, the user gives an input to the mobile terminal, the input indicating that the user wishes to watch television. The input may also indicate a particular television channel. The user gives the input through the user input device 110 of the mobile terminal 100. In S2, a DVB-H receiver (media content receiver 108) receives a command that the DVB-H reception is to be switched on. Accordingly, a media content stream broadcasted through the DVB-H broadcasting system 208 is received through the DVB-H receiver. Upon the reception of a command to start presenting the received media content stream in S3, the audiovisual interface 102 starts presenting the media content (video and audio) to the user.

After watching the television for a while, the user may wish to put the mobile terminal aside and do something else (resume working, read a book, cook, etc.) but still follow the program being currently broadcasted. Alternatively, the quality of the DVB-H reception may degrade such that watching the program becomes uncomfortable or even impossible. Then, the user may wish to receive the program through the 3G network. In S4, the user gives an input that the reception of the program should be switched to the 3G network. The user may also give an input indicating a television channel he/she wishes to receive, or the channel may be determined from the channel the user was watching. In response to the user input, the DVB-H receiver receives a command that DVB-H reception should be terminated in S5 and the DVB-H receiver terminates the DVB-H reception in S6.

In response to the user input to switch the reception from the DVB-H broadcasting reception to the 3G network reception, a 3G module (communication interface 106) also receives in S7 a command to activate the reception of the media content stream through the 3G network. The 3G module may also receive information on the quality of the received content. The quality of the received content may be preset by the user. The information on the quality of the received content may comprise the quality of the audio component of the received media content stream as well as the quality of the received images. The 3G module may also receive information on the type of the reception, for example reception of only audio or video (still images) component of the media content stream. The user may wish only to listen to the media content stream and he/she may deactivate the reception of the images accordingly. The 3G module then transmits a channel assignment request to the 3G wireless communication network 210 in S8 for the assignment of a downlink channel for the reception of the media content stream being broadcasted through the broadcasting system. The request may also comprise information on which media content is to be received (television channel information and information on the quality and type of the reception). The 3G network 210 then assigns a downlink channel for the mobile terminal 100 and also conveys the request for the transmission of the media content stream as well as media content information to the 3G content creation unit 206 in S9.

In S10 and S11, the 3G content creation unit 206 transmits the requested media content stream to the 3G module of the mobile terminal 100 through the 3G wireless communication network. This media content stream corresponds to the media content stream being broadcasted through the DVB-H broadcasting system 208. Accordingly, the same media content is being transmitted through the broadcasting system and the wireless communication network substantially at the same time. Obviously, there exist time differences between the two different systems due to different processing of the media content streams. As mentioned above, the media content stream transmitted through the 3G network may be processed into a lower data rate stream with respect to the broadcasted media content stream.

In S12, the received media content stream is conveyed to the audiovisual interface 102 of the mobile terminal 100 and is presented to the user. In S13 and S14, the transmission of a media content stream through the 3G wireless communication network to the mobile terminal 100 is continued. The media content transmitted in S14 and S15 and received at the mobile terminal 100 is presented to the user through the audiovisual interface in S15.

In S16, the user wishes to switch the television off and gives the corresponding input through the user input device 110. In response to the input, a command to terminate the reception of the media content stream is transmitted to the 3G module in S17. The 3G module then transmits a request to terminate the reception of the media content stream to the 3G wireless communication network in S18. The request to terminate the reception of the media content stream may comprise a request for releasing the downlink channel that was used for transmitting the media stream content to the mobile terminal 100. Accordingly, the 3G network transmits the corresponding request to the 3G content creation unit 206 in S19. Then, the 3G content creation unit 206 terminates the transmission of the media content stream to the mobile terminal 100.

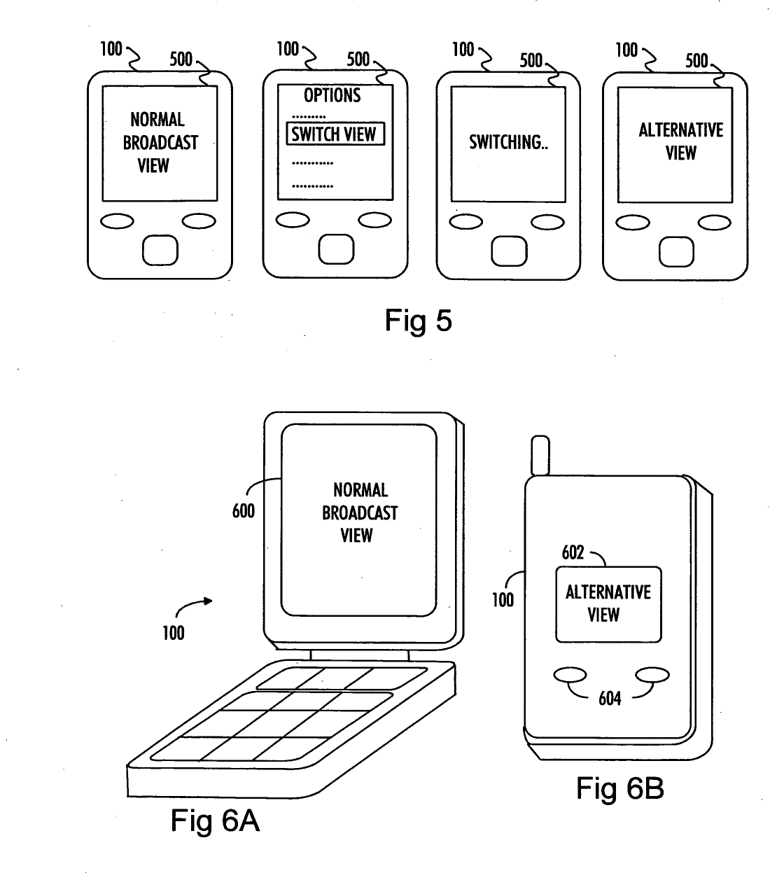

Next, the presentation of the media content stream to the user by using the audiovisual interface 102 of the mobile terminal 100 will be described with reference to FIGS. 5, 6A, and 6B. FIG. 5 illustrates a mobile terminal 100 with one display unit 500, and FIGS. 6A and 6B illustrate a fliptype mobile terminal (a mobile phone) comprising two display units, i.e. a primary display unit 600 and a secondary display unit 602.

FIG. 5 illustrates an example of switching the display mode from a broadcast view to an alternative view in the mobile terminal 100 with one display unit 500. A television program is first received through the media content receiver 108 (the DVB-H receiver) and the program is displayed in the display unit 500 in a normal broadcast view. The video component of the received media content (the television program) is displayed as a streaming media. The sound of the program is played through the sound production system (not shown) of the mobile terminal 100.

Then, the user wishes to switch the reception of the television program from the broadcasting system to the wireless communication network. Accordingly, the user switches the display mode. The user may select a corresponding option from the options menu of a media player software application. Altematively, the user may press a specific button of the user input device of the mobile terminal 100. In response to the input from the user, the mobile terminal 100 terminates the DVB-H reception and starts the reception of the television program through the wireless communication network. At the same time, the mobile terminal 100 switches the display mode to correspond to the reception of the program through the wireless communication network. Now, the video component of the received media content stream is received as images with determined time intervals between the images. These images are then displayed as an alternative view in the display unit 500. If the determined time interval between the received images is, for example, one second, the displayed image changes to another at one-second intervals. The audio component of the received media content stream may be received as a continuous stream but with a lower data rate, i.e. lower quality. The audio component may then be played as a continuous audio stream through the sound production system (not shown) of the mobile terminal 100.

FIGS. 6A and 6B illustrate an example of switching the display mode from a broadcast view to an alternative view in the flip-type mobile terminal 100 with two display units 600 and 602. Accordingly, the mobile terminal 100 comprises the primary display unit 600 which is used when the mobile terminal is in an operational state. The operational state means the state illustrated in FIG. 6A. In this state, the user may use the mobile terminal for making a phone call, executing an application, browsing through the menus, browsing the Internet, etc. The mobile terminal 100 also comprises the secondary display unit 602 which may be used at least when the mobile terminal is in a stand-by state illustrated in FIG. 6B.

Now, let us assume that the user of the mobile terminal has activated the DVB-H reception and the mobile terminal is in the operational state as illustrated in FIG. 6A. The mobile terminal 100 may receive a television program through the DVB-H broadcasting system and present the received program to the user through the audiovisual interface. The video component of the program may be displayed in the primary display unit 600 as the normal broadcast view. When the user changes the state of the mobile terminal 100 to the stand-by state illustrated in FIG. 6B while the program is being presented to the user, the mobile terminal 100 may interpret this as an input to change the display mode of the program to the alternative view. The mobile terminal 100 may also terminate the DVB-H reception and start the reception of the program through the wireless communication network. The mobile terminal 100 may ask the user to enter a confirmation for the reception of the program through the wireless communication network. Now that the mobile terminal 100 has been put into stand-by state and the reception of the program through the wireless communication network has been started, the video component of the program is displayed to the user in the secondary display unit 602. The video component may again be displayed as images with determined time intervals between the images. The mobile terminal 100 may comprise buttons 604 or other input means for enabling the user to operate the mobile terminal in the stand-by state. The buttons 604 may be used for changing the television channel, for example. If the user changes the state of the mobile terminal 100 back to the operational state, the display mode may be switched accordingly into the normal broadcast view. The reception of the program may also be changed back to the DVB-H system.

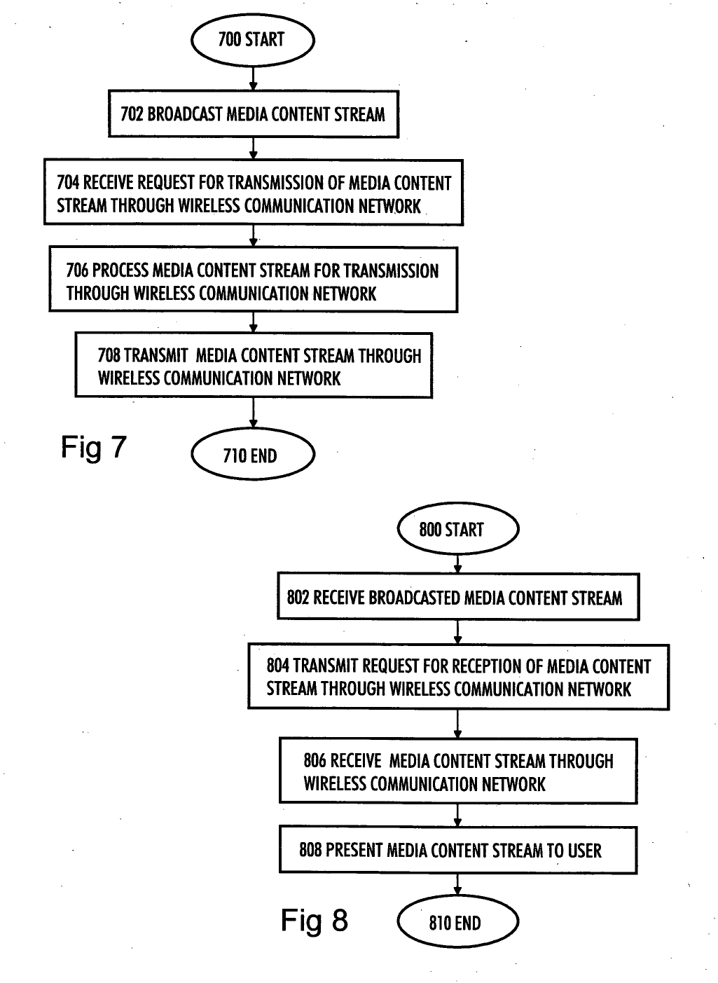

FIG. 7 illustrates a process for providing a media content stream to mobile terminals of a wireless communication network. The process starts in block 700. In block 702, a media content stream is broadcasted through a broadcasting system. The broadcasting system may be a DVB-H broadcasting system and the media content stream may be broadcasted according to the DVB-H standard. The broadcasted media content stream may be received by the mobile terminals of the wireless communication network. In block 704, a request for the transmission of the media content stream through the wireless communication network is received from a mobile terminal of the wireless communication network. In block 706, the media content stream to be transmitted through the wireless communication network is processed for transmission. The processing may comprise steps for decreasing the data rate of the media content stream with respect to the data rate of the broadcasted media content stream. In block 708, the processed media content stream is transmitted to the mobile terminal through the wireless communication network while broadcasting the media content stream through the broadcasting system. The media content stream transmitted through the wireless communication network and the media content stream broadcasted through the broadcasting system may be related to the same media content. The process ends in block 710.

FIG. 8 is another flow chart illustrating a process for media content stream reception in a mobile terminal of a wireless communication network. The process starts in block 800. In block 802, a media content stream is received in the mobile terminal. The media content stream may be received from a broadcasting system. In block 804, a request for the reception of at least a portion of the media content stream through a wireless communication network is transmitted. The portion of the media content stream may be the media content stream being broadcasted but with a lower data rate. The request may be transmitted to the wireless communication network. The request may comprise a downlink channel assignment request for the reception of the at least a portion of the media content stream. In block 806, the at least a portion of the media content stream is received through the wireless communication network, and the received media content stream is presented to a user of the mobile terminal in block 808. The process ends in block 810.

Embodiments of the invention may be realized in an arrangement comprising a media content production unit, a broadcasting system, and a wireless communication network. The arrangement may be configured to perform at least some of the steps described in connection with the flowchart of FIG. 7 and in connection with FIGS. 2, 3, and 4. The embodiments may be implemented as a computer program comprising instructions for providing a media content stream to mobile terminals of a wireless communication network.

Other embodiments of the invention may be realized in a mobile terminal of a wireless communication network, the mobile terminal comprising a media content receiver, a communication interface, and an audiovisual interface. The mobile terminal also comprises a processing unit operationally connected to the media content receiver, a communication interface, and an audiovisual interface. The processing unit may be configured to perform at least some of the steps described in connection with the flowchart of FIG. 8 and in connection with FIGS. 4, 5, 6A, and 6B. The embodiments may be implemented as a computer program comprising instructions for executing a computer process for media content stream reception in the mobile terminal.

Each of the computer programs may be stored on a computer program distribution medium readable by a computer or a processor. The computer program medium may be, for example but not limited to, an electric, magnetic, optical, infrared, or semiconductor system, device, or transmission medium. The computer program medium may include at least one of the following media: a computer readable medium, a program storage medium, a record medium, a computer readable memory, a random access memory, an programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims.

1. A method for providing a media content stream to mobile terminals of a wireless communication network, the method comprising:
broadcasting, through a broadcasting system, the media content stream to the mobile terminals;
receiving, from a mobile terminal of the wireless communication network, a request for the transfer of at least a portion of the media content stream being broadcasted, the transfer of the at least a portion of the media content stream being requested to be carried out through a downlink channel of the wireless communication network; and
transmitting, in response to the request, the at least a portion of the media content stream to the mobile terminal through the downlink channel of the wireless communication network while broadcasting the media content stream through the broadcasting system.

2. The method of claim 1, further comprising transmitting the media content stream to the mobile terminal through the downlink channel wireless communication network with a reduced data rate with respect to the data rate used for broadcasting the media content stream through the broadcasting system.

3. The method of claim 2, wherein the data rate of the media content stream is reduced by obtaining an image from a video component of the media content stream at determined time instants and scaling the obtained images to low-resolution images, and the low-resolution images are transmitted to the mobile terminal through the wireless communication network.

4. The method of claim 2, wherein an audio component of the media content stream is transmitted as a continuous audio stream to the mobile terminal through the wireless communication network.

5. The method of claim 1, further comprising broadcasting the media content stream by utilizing the digital video broadcasting for handheld devices (DVB-H) technique.

6. A media content stream reception method carried out in a mobile terminal of a wireless communication network, the method comprising:
receiving a media content stream broadcasted through a broadcasting system;
transmitting a downlink channel assignment request for the reception, through the wireless communication network, of at least a portion of the media content stream being broadcasted through the broadcasting system;
receiving the at least a portion of the media content stream through the wireless communication network, and
presenting the received media content stream to a user of the mobile terminal.

7. The method of claim 6, further comprising receiving the media content stream through the wireless communication network with a reduced data rate with respect to the data rate of the media content stream broadcasted through the broadcasting system.

8. The method of claim 6, further comprising receiving, before the transmission of the reception request, an input from a user of the mobile terminal, the input indicating that the media content stream is to be received through the wireless communication network.

9. The method of claim 6, further comprising receiving a video component of the media content stream as images at determined time instants and displaying the images to the user with a determined time interval between the displayed images.

10. The method of claim 6, further comprising receiving an audio component of the media content stream as a continuous audio stream and playing the audio stream to the user of the mobile terminal.

11. The method of claim 6, further comprising displaying a video component of the media content stream in a secondary display unit of the mobile terminal.

12. The method of claim 6, further comprising switching the display mode, in response to an input from the user of the mobile terminal, between the display modes of displaying the media stream content received through the broadcasting system and displaying the media stream content received through the mobile communication network.

13. An arrangement for providing media content to mobile terminals of a wireless communication network, the arrangement comprising:
a media content production unit configured to produce a media content stream to be transmitted to the mobile terminals;
a broadcasting system configured to broadcast the media content stream to the mobile terminals; and
a wireless communication network configured to transmit, in response to a request from a mobile terminal, at least a portion of the media content stream being broadcasted by the broadcasting system.

14. The arrangement of claim 13, further comprising a processing unit configured to reduce the data rate of the media content stream and to output the media content stream for transmission through the wireless communication network.

15. The arrangement of claim 14, wherein the processing unit is configured to reduce the data rate of the media content stream by extracting a video component from the media content stream, taking images from the video component at determined time instants, and scaling the obtained images to low-resolution images.

16. The arrangement of claim 14, wherein the processing unit is configured to reduce the data rate of the media content stream by processing an audio component of the media content to have a lower data rate than that of the audio component being transmitted through the broadcasting system.

17. The arrangement of claim 13, wherein the broadcasting system employs the digital video broadcasting for handheld devices (DVB-H) technique.

18. A mobile terminal of a wireless communication network, the mobile terminal comprising:
a media content receiver configured to receive a media content stream broadcasted through a broadcasting system;
a communication interface configured to transmit and receive data through the wireless communication network;
an audiovisual interface for presenting the received media content stream to a user of the mobile terminal, and
a processing unit configured to transmit a downlink channel assignment request to the wireless communication network for the reception of at least a portion of the media content stream being broadcasted through a broadcasting system, to receive, through the communication interface, the at least a portion of the media content stream, and to present the received media content stream to a user of the mobile terminal through the audiovisual interface.

19. The mobile terminal of claim 18, further comprising a user input module configured to receive inputs from the user of the mobile terminal, and the processing unit being further configured to receive, through the user input module, an input indicating that the media content stream is to be received through the wireless communication network, and to transmit the request to the wireless communication network in response to the input.

20. The mobile terminal of claim 18, wherein the processing unit is further configured to receive a video component of the media content stream as images at determined time instants and to display the images to the user with a determined time interval between the displayed images.

21. The mobile terminal of claim 18, wherein the processing unit is further configured to receive an audio component of the media content stream as a continuous audio stream and to play the audio stream to the user of the mobile terminal.

22. The mobile terminal of claim 18, wherein the processing unit is further configured to display a video component of the media content stream in a secondary display unit of the mobile terminal.

23. The mobile terminal of claim 18, wherein the processing unit is further configured to switch the display mode, in response to a mode switch input from the user, between the display modes of displaying the media stream content received through the broadcasting system and displaying the media stream content received through the mobile communication network.

24. The mobile terminal of claim 23, wherein the mobile terminal is a flip-type mobile terminal comprising a secondary display unit which is visible to the user at least when the flip is closed, a detection of the mode switch input comprises the detection of closing or opening the flip, and the processing unit is configured to start displaying, in a primary display of the mobile terminal, the media content stream received through the media content receiver when detecting that the flip is opened, and to start displaying, in the secondary display unit of the mobile terminal, the media content stream received through the communication interface when detecting that the flip is closed.

25. The mobile terminal of claim 18, wherein the media content receiver is further configured to receive a media content stream transmitted by utilizing the digital video broadcasting for handheld devices (DVB-H) technique.

26. An arrangement for transferring media content, the arrangement comprising:
a media content production unit configured to produce a media content stream to be transmitted to mobile terminals of a wireless communication network;
a broadcasting system configured to broadcast the media content stream to the mobile terminals;
a wireless communication network configured to transmit, in response to a request from a mobile terminal, at least a portion of the media content stream being broadcasted by the broadcasting system, and
a mobile terminal of the wireless communication network, the mobile terminal comprising:
a media content receiver configured to receive a media content stream broadcasted through a broadcasting system;
a communication interface configured to transmit and receive data through the wireless communication network;
an audiovisual interface for presenting the received media content stream to a user of the mobile terminal, and
a processing unit configured to transmit a downlink channel assignment request to the wireless communication network for the reception of at least a portion of the media content stream being broadcasted through a broadcasting system, to receive, through the communication interface, the at least a portion of the media content stream, and to present the received media content stream to a user of the mobile terminal through the audiovisual interface.

27. An arrangement for providing media content to mobile terminals of a wireless communication network, the arrangement comprising:
means for broadcasting, through a broadcasting system, the media content stream to the mobile terminals;
means for receiving, from a mobile terminal of the wireless communication network, a request for the transfer of at least a portion of the media content stream being broadcasted, the transfer of the at least a portion of the media content stream being requested to be carried out through a downlink channel of the wireless communication network; and
means for transmitting, in response to the request, the at least a portion of the media content stream to the mobile terminal through the downlink channel of the wireless communication network while broadcasting the media content stream through the broadcasting system.

28. A mobile terminal of a wireless communication network, the mobile terminal comprising:
means for receiving media content stream broadcasted through a broadcasting system;
means for transmitting a downlink channel assignment request for the reception, through the wireless communication network, of at least a portion of the media content stream being broadcasted through the broadcasting system;
means for receiving the at least a portion of the media content stream through the wireless communication network, and
means for presenting the received media content stream to a user of the mobile terminal.

29. An arrangement for providing media content to mobile terminals of a wireless communication network, the arrangement comprising:
means for broadcasting, through a broadcasting system, the media content stream to the mobile terminals;
means for receiving the media content stream;
means for transmitting a downlink channel assignment request for the reception, through the wireless communication network, of at least a portion of the media content stream being broadcasted through the broadcasting system;
means for receiving the request for transfer of at least a portion of the media content stream being broadcasted, the transfer of the at least a portion of the media content stream being requested to be carried out through a downlink channel of the wireless communication network;
means for transmitting, in response to the request, the at least a portion of the media content stream to the mobile terminal through the downlink channel of the wireless communication network while broadcasting the media content stream through the broadcasting system;
means for receiving the at least a portion of the media content stream through the wireless communication network, and
means for presenting the received media content stream to a user of the mobile terminal.

30. A computer program distribution medium readable by a computer and encoding a computer program of instructions for executing a computer process for media content stream reception in a mobile terminal of a wireless communication network, the process comprising:
transmitting a downlink channel assignment request for the reception, through the wireless communication network, of at least a portion of the media content stream being broadcasted through a broadcasting system;
receiving the at least a portion of the media content stream through the wireless communication network, and
presenting the received media content stream to a user of the mobile terminal.

31. The computer program distribution medium of claim 30, the distribution medium including at least one of the following media: a computer readable medium, a program storage medium, a record medium, a computer readable memory, a computer readable software distribution package, a computer readable signal, a computer readable telecommunications signal, and a computer readable compressed software package.

32. A computer program distribution medium readable by a computer and encoding a computer program of instructions for providing a media content stream to mobile terminals of a wireless communication network, the process comprising:
broadcasting through a broadcasting system the media content stream to the mobile terminals;
receiving from a mobile terminal of the wireless communication network a request for the transfer of at least a portion of the media content stream being broadcasted, the transfer of the at least a portion of the media content stream being requested to be carried out through a downlink channel of the wireless communication network;
converting the media content stream to a format suitable for transmission through the wireless communication, and
transmitting, in response to the request, the at least a portion of the media content stream to the mobile terminal through the downlink channel of the wireless communication network while broadcasting the media content stream through the broadcasting system.

33. The computer program distribution medium of claim 32, the distribution medium including at least one of the following media: a computer readable medium, a program storage medium, a record medium, a computer readable memory, a computer readable software distribution package, a computer readable signal, a computer readable telecommunications signal, and a computer readable compressed software package.
